(19) United States
(12) Patent Application Publication
(10) Pub. No.: US 2023/0415316 A1
(43) Pub. Date: Dec. 28, 2023

(54) ELECTRIC POWER TOOL

(71) Applicant: BASSO INDUSTRY CORP., Taichung (TW)

(72) Inventors: Cheng-En Tsai, Taichung (TW); Chong-Kun Hong, Taichung (TW)

(73) Assignee: BASSO INDUSTRY CORP., Taichung (TW)

(21) Appl. No.: 18/339,386

(22) Filed: Jun. 22, 2023

(30) Foreign Application Priority Data
Jun. 24, 2022 (TW) 111123732

(51) Int. Cl. B25C 1/00; B25C 1/06

(52) U.S. Cl. CPC B25C 1/008; B25C 1/06

(57) ABSTRACT

An electric power tool includes a battery, a first switch connected to the battery, a driving unit, a sensing unit, a primary controller and a secondary controller. The driving unit includes a motor, a second switch connected to the motor and the first switch, and a switch-control circuit connected to the second switch. The sensing unit outputs a detection result to the primary and secondary controllers. The primary controller disables the driving unit when it is determined that there is a malfunction based on the detection result. The secondary controller controls the first switch to operate in a non-conducting state to cut off electricity supplied from the battery to the second switch when it is determined that there is a malfunction based on the detection result. When the first switch operates in a conducting state, the second switch provides the electricity to the motor under control of the switch-control circuit.

### CROSS-REFERENCE TO RELATED APPLICATION

This application claims priority to Taiwanese Invention Patent Application No. 111123732, filed on Jun. 24, 2022.

### FIELD

The disclosure relates to an electric power tool, and more particularly to an electric power tool with a dual safety mechanism.

### BACKGROUND

With the advancements in terms of functionality of power tools, architectures of electric power tools have become more complex. When an electric power tool operates abnormally because of failure of one component (e.g., a switch or a sensor) of the electric power tool or adverse environmental conditions, the electric power tool may become unsafe for a user.

### SUMMARY

Therefore, an object of the disclosure is to provide an electric power tool that can alleviate at least one of the drawbacks of the prior art.

According to the disclosure, the electric power tool includes a power supply, a driving unit, a sensing unit and a control unit.

The power supply includes a battery and a first switch circuit. The battery is configured to supply electricity. The first switch circuit is electrically connected to the battery, and is configured to receive the electricity supplied by the battery and to operate in one of a conducting state and a non-conducting state.

The driving unit includes a second switch circuit, a motor and a switch-control circuit. The second switch circuit is electrically connected to the first switch circuit, and is configured to operate in one of a conducting state and a non-conducting state. The motor is electrically connected to the second switch circuit. The switch-control circuit is electrically connected to the second switch circuit, and is configured to control the second switch circuit to drive the motor.

The sensing unit is configured to detect conditions of the power supply and the driving unit, and to output a detection result related to the conditions thus detected.

The control unit includes a primary controller and a secondary controller. The primary controller is electrically connected to the power supply, the driving unit and the sensing unit, and is configured to receive the detection result from the sensing unit. The secondary controller is electrically connected to the power supply and the sensing unit, and is configured to receive the detection result from the sensing unit.

When the first switch circuit operates in the conducting state, the second switch circuit receives the electricity supplied by the battery from the first switch circuit, and provides, under control of the switch-control circuit, the electricity to the motor for driving the motor to operate.

The primary controller is configured to disable the driving unit when it is determined by the primary controller that there is a malfunction based on the detection result.

The secondary controller is configured to control the first switch circuit to operate in the non-conducting state to cut off the electricity supplied from the battery to the second switch circuit when it is determined by the secondary controller that there is a malfunction based on the detection result.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an electric power tool according to a first embodiment of the disclosure.

FIG. 2 is a schematic diagram illustrating electronic components in a first switch circuit of the electric power tool according to an embodiment of the disclosure.

FIG. 3 is a circuit diagram illustrating electronic components in a trigger sensor of the electric power tool according to an embodiment of the disclosure.

FIG. 4 is a flow chart illustrating an operation procedure of the electric power tool when the electric power tool is under normal operation according to the first embodiment of the disclosure.

FIG. 5 is a block diagram illustrating the electric power tool according to a second embodiment of the disclosure.

FIG. 6 is a flow chart illustrating an operation procedure of the electric power tool when the electric power tool is under normal operation according to the second embodiment of the disclosure.

FIG. 7 is a schematic diagram illustrating an example of the electric power tool according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

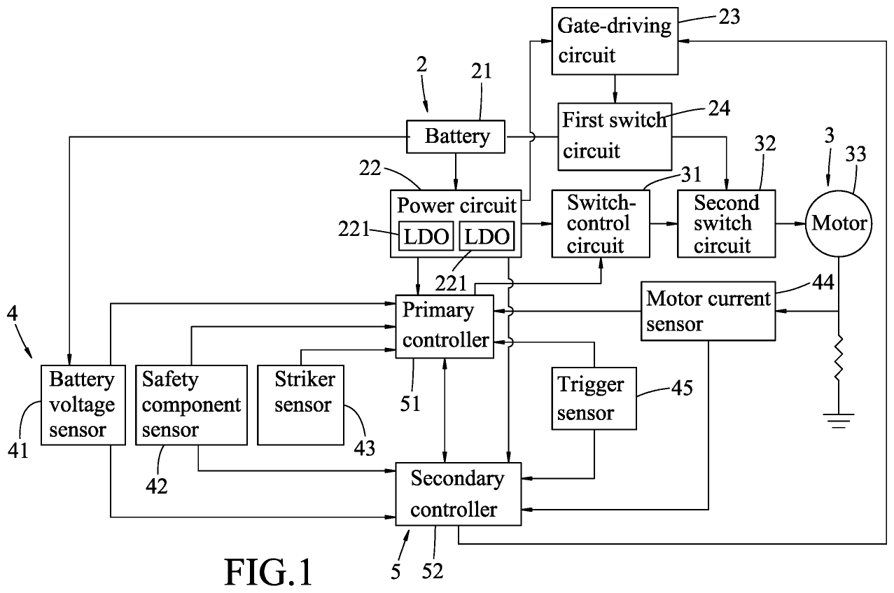

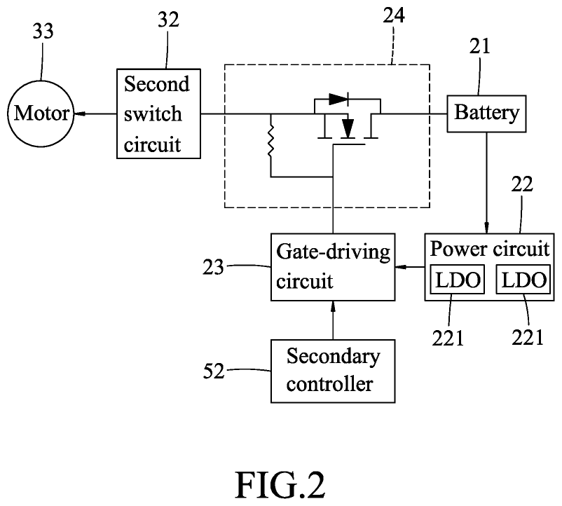

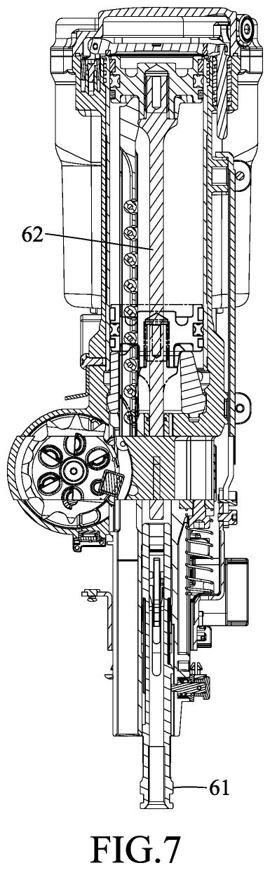

Referring to FIGS. 1, 2 and 7, a first embodiment of an electric power tool according to the disclosure is illustrated. The electric power tool is exemplarily a nail gun, but is not limited thereto. Particularly, the electric power tool may be a pneumatic nail gun or an electric nail gun. Since technical details about the pneumatic nail gun and the electric nail gun have been well known to one skilled in the relevant art, detailed explanation of the same is omitted herein for the sake of brevity.

The electric power tool includes a power supply 2, a driving unit 3, a sensing unit 4, a control unit 5, a safety component 61, a striker 62 and a trigger (not shown).

The power supply 2 includes a battery 21, a power circuit 22, a gate-driving circuit 23 and a first switch circuit 24. The battery 21 is configured to supply electricity. In this embodiment, the electricity supplied by the battery 21 has a voltage of 18 V, but is not limited thereto. The first switch circuit 24 is electrically connected to the battery 21, and is configured to receive the electricity supplied by the battery 21 and to operate in one of a conducting state and a non-conducting state. The first switch circuit 24 may be implemented to include a semiconductor switch (e.g., a metal-oxide-semiconductor field-effect transistor, MOSFET, or an insulated gate bipolar transistor, IGBT), but is not limited thereto. The power circuit 22 is configured to perform voltage regulation and voltage conversion on the electricity provided by the battery 21 and to transfer the electricity thus processed to other components of the electric power tool. In this embodiment, the power circuit 22 includes two low-dropout (LDO) regulators 221. The electricity is processed by the two LDO regulators 221 to have two voltages, 5 V and 12 V, respectively. Since implementation of the power circuit 22 has been well known to one skilled in the relevant art, detailed explanation of the same is omitted herein for the sake of brevity. The gate-driving circuit 23 is electrically connected to the control unit 5 and the power circuit 22, and is configured to receive the electricity that is processed by one of the two LDO regulators 221 of the power circuit 22 and that exemplarily has a voltage of 12 V. The gate-driving circuit 23 is further configured to be controlled by the control unit 5 to drive the first switch circuit 24 to operate in one of the conducting state and the non-conducting state. The gate-driving circuit 23 is exemplarily implemented by a gate driver, receives a switch-control signal outputted by the control unit 5, and supplies, based on the switch-control signal received from the control unit a suitable voltage to a gate of the semiconductor switch in the first switch circuit 24 to enable to the semiconductor switch to be conducting or non-conducting.

The driving unit 3 includes a switch-control circuit 31, a second switch circuit 32 and a motor 33. The second switch circuit 32 is electrically connected to the first switch circuit 24, and is configured to operate in one of a conducting state and a non-conducting state. The motor 33 is electrically connected to the second switch circuit 32. The switch-control circuit 31 is electrically connected to the control unit 5, the second switch circuit 32 and the power circuit 22, and is configured to control the second switch circuit 32 to drive the motor 33. The switch-control circuit 31 is configured to receive the electricity that is processed by one of the two LDO regulators 221 of the power circuit 22 and that exemplarily has a voltage of 12 V. The switch-control circuit 31 is further configured to receive a pulse-width modulation (PWM) signal outputted by the control unit 5, and to control the second switch circuit 32 based on a duty ratio of the PWM signal so as to enable the motor 33 to operate at a specific speed corresponding to the duty ratio. In one embodiment, a signal outputted by the second switch circuit 32 for driving the motor 33 to operate is also a PWM signal. The second switch circuit 32 may be implemented to include a semiconductor switch (e.g., a MOSFET or an IGBT), but is not limited thereto. The motor 33 may be implemented by a brushless DC electric motor (BLDC), but is not limited thereto. Since implementation of the switch-control circuit 31 has been well known to one skilled in the relevant art, detailed explanation of the same is omitted herein for the sake of brevity.

When the first switch circuit 24 operates in the conducting state, the second switch circuit 32 receives the electricity supplied by the battery 21 from the first switch circuit 24, and provides, under control of the switch-control circuit 31, the electricity to the motor 33 in order to drive the motor 33 to operate. It is worth to note that the electricity provided to the motor 33 exemplarily has a voltage of 18 V.

The control unit 5 includes a primary controller 51 and a secondary controller 52.

The sensing unit 4 is configured to detect conditions of the power supply 2, the driving unit 3, the safety component 61, the striker 62 and the trigger, and to output a detection result related to the conditions thus detected. The sensing unit 4 includes a plurality of sensors. At least one of the plurality of sensors is configured to output at least one detection signal to both the primary controller 51 and the secondary controller 52. The detection result includes the at least one detection signal. In this embodiment, the plurality of sensors include a battery voltage sensor 41, a safety component sensor 42, a striker sensor 43, a motor current sensor 44 and a trigger sensor 45. However, in other embodiments, the types of the sensors and connections between the sensing unit 4 and the control unit 5 may vary based on practical needs.

The battery voltage sensor 41 is electrically connected to the battery 21, and to the primary controller 51 and the secondary controller 52. The battery voltage sensor 41 is configured to detect a voltage value of the battery 21, and to output the voltage value to the primary controller 51 and the secondary controller 52.

The motor current sensor 44 is electrically connected to the motor 33, and to the primary controller 51 and the secondary controller 52. The motor current sensor 44 is configured to detect a current value of the motor 33, and to output the current value to the primary controller 51 and the secondary controller 52.

The safety component sensor 42 is configured to determine whether the safety component 61 is pressed against an object.

The striker sensor 43 is configured to determine whether the striker 62 has returned to a predetermined position after a striking operation.

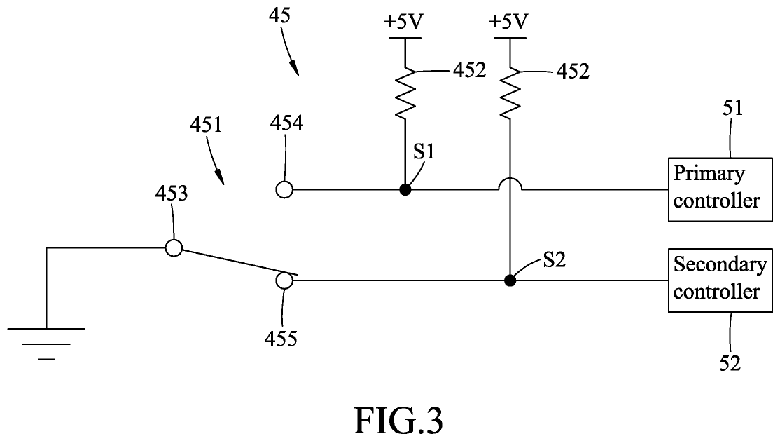

The trigger sensor 45 is configured to determine whether the trigger is pressed. Specifically, referring to FIGS. 1 and 3, the trigger sensor 45 includes a micro switch 451 and two resistors 452. The micro switch 451 has a first terminal 453 that is electrically connected to a low voltage terminal (e.g., 0 V), a second terminal 454 that is electrically connected to the primary controller 51, and a third terminal 455 that is electrically connected to the secondary controller 52. The micro switch 451 is co-operable with the trigger, and is configured to switch, upon the trigger being pressed, to one of a first state where the first terminal 453 and the second terminal 454 are connected while the first terminal 453 and the third terminal 455 are disconnected, and a second state where the first terminal 453 and the second terminal 454 are disconnected while the first terminal 453 and the third terminal 455 are connected. One end of each of the two resistors 452 is electrically connected to a high voltage terminal (e.g., 5 V), the other end of one of the two resistors 452 is electrically connected to the second terminal 454 of the micro switch 451, and the other end of the other one of the two resistors 452 is electrically connected to the third terminal 455 of the micro switch 451. It should be noted that regardless of which one of the first state and the second state the micro switch 451 is switched to, voltages respectively of two nodes (S1, S2) in FIG. 3 would vary upon switching of the micro switch 451, and each of the primary controller 51 and the secondary controller 52 determines that the trigger is pressed when it is determined that the voltage of the corresponding one of the two nodes (S1, S2) varies.

It should be noted that since implementations of the battery voltage sensor 41, the safety component sensor 42, the striker sensor 43, the motor current sensor 44 and the trigger sensor 45 have been well known to one skilled in the relevant art, detailed explanation of the same is omitted herein for the sake of brevity.

The primary controller 51 is electrically connected to the power supply 2, the driving unit 3 and the sensing unit 4, and is configured to receive the detection result from the sensing unit 4. The secondary controller 52 is electrically connected to the power supply 2 and the sensing unit 4, and is configured to receive the detection result from the sensing unit 4. The primary controller 51 and the secondary controller 52 are in communication with each other (e.g., through a wired connection or a wireless connection) and are further configured to provide information that is related to the detection result (received from the sensing unit 4) to each other. Each of the primary controller 51 and the secondary controller 52 may be implemented by a processor, a central processing unit (CPU), a microprocessor, a micro control unit (MCU), a system on a chip (SoC), or any circuit configurable/programmable in a software manner and/or hardware manner to implement functionalities discussed in this disclosure and functions of analog-to-digital (A/D) conversion, input/output (I/O) detection and PWM output.

The primary controller 51 is configured to determine whether there is a malfunction based on the detection result and the information provided by the secondary controller 52. The primary controller 51 is configured to disable the driving unit 3 when it is determined by the primary controller 51 that there is a malfunction based on the detection result and the information provided by the secondary controller 52. Specifically, the primary controller 51 outputs the PWM signal with zero duty ratio to the switch-control circuit 31 to control the second switch circuit 32 to operate in the non-conducting mode. Unable to receive the electricity from the battery 21 via the second switch circuit 32, the motor 33 is hence disabled.

The secondary controller 52 is configured to determine whether there is a malfunction based on the detection result and the information provided by the primary controller 51. The secondary controller 52 is configured to control the gate-driving circuit 23 to drive the first switch circuit 24 to operate in the non-conducting state to cut off the electricity supplied from the battery 21 to the second switch circuit 32 when it is determined by the secondary controller 52 that there is a malfunction based on the detection result and the information provided by the primary controller 51.

For example, in a case where the primary controller 51 determines that the trigger is pressed based on the detection signal provided by the trigger sensor 45, but determines that the trigger is not pressed based on the information provided by the secondary controller 52, since two results respectively of the aforesaid two determinations are in conflict with each other, the primary controller 51 determines that there is a malfunction. As another example, a case may be that the primary controller 51 determines that the trigger is pressed based on the detection signal provided by the trigger sensor 45, but the primary controller 51 does not receive from the secondary controller 52 the information as to whether the trigger is pressed, in such a situation, the primary controller 51 determines that there is a malfunction.

The secondary controller 52 is configured to, when it is determined by both the primary controller 51 and the secondary controller 52 that there is no malfunction, control the gate-driving circuit 23 to drive the first switch circuit 24 to operate in the conducting state prior to the primary controller 51 enabling the switch-control circuit 31 to control the second switch circuit 32 to provide the electricity to the motor 33 for driving the motor 33 to operate. In this way, abnormal operation of the motor 33 due to inappropriate control of the motor 33 may be prevented.

To ensure that the first switch circuit 24 operates in the conducting state before the second switch circuit 32 is controlled to provide the electricity to the motor 33, in one embodiment, the primary controller 51 is configured to enable the switch-control circuit 31 to control the second switch circuit 32 to drive the motor 33 after receiving from the secondary controller 52 a notification indicating that the secondary controller 52 has controlled the gate-driving circuit 23 to drive the first switch circuit 24 to operate in the conducting state. In one embodiment, the secondary controller 52 transmits a notification to the primary controller 51 while controlling the gate-driving circuit 23 to drive the first switch circuit 24 to operate in the conducting state, and the primary controller 51 is configured to, after a preset time period (e.g., one second) counting from receipt of the notification has elapsed, enable the switch-control circuit 31 to control the second switch circuit 32 to drive the motor 33.

It is worth to note that in order to enhance reliability of the electric power tool by using a redundancy mechanism, in one embodiment, the sensing unit 4 includes at least one pair of sensors for at least one to-be-detected component of the electric power tool. For example, said at least one pair of sensors may include two battery voltage sensors 41 for detecting the voltage value of the battery 21, wherein one of the battery voltage sensors 41 is electrically connected to the primary controller 51, and the other of the battery voltage sensors 41 is electrically connected to the secondary controller 52. In this way, the electric power tool may be able to function as normal even when a failure occurs in one of the two battery voltage sensors 41 because the other of the two battery voltage sensors 41 is still able to provide the voltage value to the corresponding one of the primary controller 51 and the secondary controller 52. The primary controller 51 and the secondary controller 52 are capable of communicating with each other to share information of the voltage value.

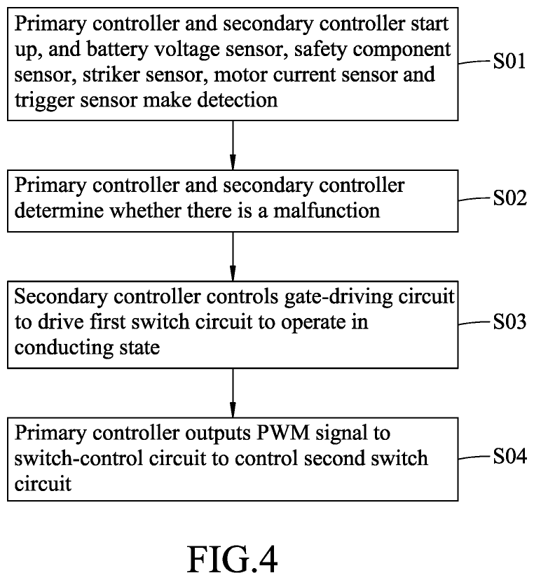

FIG. 4 illustrates a first embodiment of an operation procedure of the electric power tool according to the disclosure. The operation procedure includes steps S01 to S04 delineated below.

In step S01, after a user turns on the electric power tool, e.g., by pressing the trigger of the electric power tool, the primary controller 51 and the secondary controller 52 start up. At the same time, the sensing unit 4 detects conditions related to the electric power tool, and provides the detection result to the control unit 5. Specifically, the battery voltage sensor 41, the safety component sensor 42, the striker sensor 43, the motor current sensor 44 and the trigger sensor 45 of the sensing unit 4 start to make detections, and output the detection signals to the primary controller 51 and the secondary controller 52.

It is worth to note that at this time of the operation procedure, the first switch circuit 24 operates in the non-conducting state, and therefore, the electricity cannot be supplied from the battery 21 through the first switch circuit 24 and the second switch circuit 32 to the motor 33 for operation of the motor 33.

In step S02, the primary controller 51 and the secondary controller 52 are in communication with each other, and provide the information that is related to the detection result received from the sensing unit 4 to each other. Then, each of the primary controller 51 and the secondary controller 52 determines whether there is a malfunction based on the detection result and the information provided by the other of the primary controller 51 and the secondary controller 52. When the primary controller 51 and the secondary controller 52 both determine that there is no malfunction, a flow of the operation procedure proceeds to steps S03 and S04.

In step S03, the secondary controller 52 controls the gate-driving circuit 23 to drive the first switch circuit 24 to operate in the conducting state for enabling the second switch circuit 32 to receive the electricity from the battery 21.

In step S04, the primary controller 51 outputs the PWM signal to the switch-control circuit 31 to control the second switch circuit 32 based on the duty ratio of the PWM signal so as to drive the motor 33 to operate.

It should be noted after the motor 33 is driven to operate, each of the primary controller 51 and the secondary controller 52 continuously determines whether there is a malfunction; that is to say, step S02 is performed repeatedly. When the primary controller 51 determines in step S02 that there is a malfunction, the primary controller 51 enables the switch-control circuit 31 to control the second switch circuit 32 to operate in the non-conducting mode for disabling the motor 33. When the secondary controller 52 determines in step S02 that there is a malfunction, the secondary controller 52 controls the gate-driving circuit 23 to drive the first switch circuit 24 to operate in the non-conducting state to cut off the electricity supplied from the battery 21 to the second switch circuit 32, if any.

For example, in a scenario where the battery voltage sensor 41 malfunctions such that the primary controller 51 receives the detection signal but the secondary controller 52 does not receive the detection signal, the secondary controller 52 determines that there is a malfunction, controls the gate-driving circuit 23 to drive the first switch circuit 24 to operate in the non-conducting state, and notifies the primary controller 51 by outputting the information indicating that there is a malfunction. In response to receipt of the information from the secondary controller 52, the primary controller 51 determines that there is a malfunction, and enables the switch-control circuit 31 to control the second switch circuit 32 to operate in the non-conducting mode for disabling the motor 33.

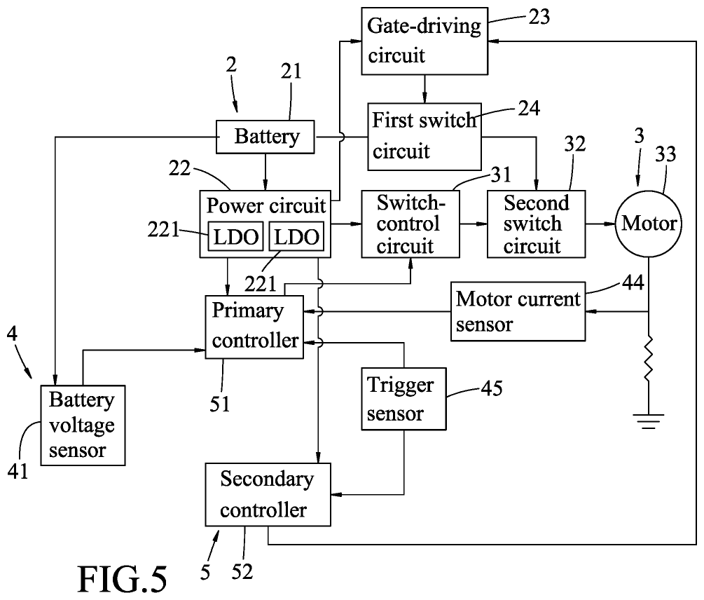

Referring to FIG. 5, a second embodiment of the electric power tool according to the disclosure is illustrated. The second embodiment of the electric power tool is similar to the first embodiment of the electric power tool, but is different therefrom in aspects described as follows.

The plurality of sensors of the sensing unit 4 include a battery voltage sensor 41, a motor current sensor 44 and a trigger sensor 45. The battery voltage sensor 41 and the motor current sensor 44 are electrically connected to the primary controller 51, but are not electrically connected to the secondary controller 52. The trigger sensor 45 is electrically connected to both the primary controller 51 and the secondary controller 52. In addition, the primary controller 51 and the secondary controller 52 are not in communication with each other.

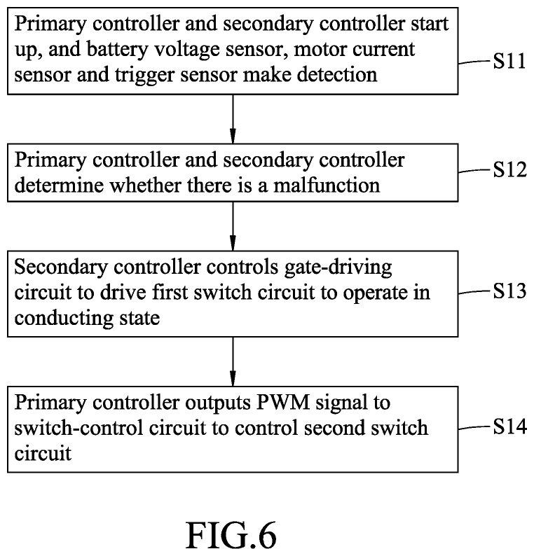

FIG. 6 illustrates a second embodiment of the operation procedure of the electric power tool according to the disclosure. The operation procedure includes steps S11 to S14 delineated below.

In step S11, after the user turns on the electric power tool, e.g., by pressing the trigger of the electric power tool, the primary controller 51 and the secondary controller 52 start up. At the same time, the sensing unit 4 detects conditions related to the electric power tool, and provides the detection result to the control unit 5. Specifically, the battery voltage sensor 41 and the motor current sensor 44 of the sensing unit 4 start to make detections, and output the detection signals to the primary controller 51. The trigger sensor 45 starts to make detections, and outputs the detection signal to the primary controller 51 and the secondary controller 52.

It is worth to note that at this point in the operation procedure, the first switch circuit 24 operates in the non-conducting state, and therefore, the electricity cannot be supplied from the battery 21 through the first switch circuit 24 and the second switch circuit 32 to the motor 33 for operation of the motor 33.

In step S12, the primary controller 51 determines whether there is a malfunction based on the detection signals outputted by the battery voltage sensor 41, the motor current sensor 42 and the trigger sensor 45, and the secondary controller 52 determines whether there is a malfunction based on the detection signal outputted by the trigger sensor When the primary controller 51 and the secondary controller 52 determines that there is no malfunction, a flow of the operation procedure proceeds to steps S13 and S14.

In step S13, the secondary controller 52 controls the gate-driving circuit 23 to drive the first switch circuit 24 to operate in the conducting state for enabling the second switch circuit 32 to receive the electricity from the battery 21.

In step S14, the primary controller 51 outputs the PWM signal to the switch-control circuit 31 to control the second switch circuit 32 based on the duty ratio of the PWM signal so as to enable the motor 33 to rotate.

Similarly, after the motor 33 is enabled to operate, each of the primary controller 51 and the secondary controller 52 continuously determines whether there is a malfunction; that is to say, step S12 is performed repeatedly. When the primary controller 51 determines that there is a malfunction, the primary controller 51 enables the switch-control circuit 31 to control the second switch circuit 32 to operate in the non-conducting mode for disabling the motor 33. When the secondary controller 52 determines that there is a malfunction, the secondary controller 52 controls the gate-driving circuit 23 to drive the first switch circuit 24 to operate in the non-conducting state to cut off the electricity supplied from the battery 21 to the second switch circuit 32, if any.

For example, in a scenario where the trigger sensor 45 malfunctions such that the primary controller 51 receives the corresponding detection signal from the trigger sensor 45 but the secondary controller 52 does not receive the corresponding detection signal from the trigger sensor 45, the primary controller 51 determines that there is no malfunction, and outputs the PWM signal to the switch-control circuit 31 to control the second switch circuit 32, but the secondary controller 52 determines that there is a malfunction, and controls the gate-driving circuit 23 to drive the first switch circuit 24 to operate in the non-conducting state to cut off the electricity supplied from the battery 21 to the second switch circuit 32. Unable to receive the electricity from the battery 21 via the second switch circuit 32, the motor 33 cannot operate. In this way, potential danger in using the electrical power tool when there is a malfunction in one of the sensors may be prevented.

To sum up, the electric power tool according to the disclosure utilizes a dual safety mechanism in the control unit 5 (i.e., the primary controller 51 and the secondary controller 52) to enhance reliability and safety of using the electric power tool. By virtue of two independent determinations as to whether a malfunction has occurred (realized by the dual safety mechanism), the risk of using the electric power tool while operation of the electric power tool is abnormal in view of failure of a single controller may be alleviated. In addition, the secondary controller 52 controls the first switch circuit 24 to operate in the non-conducting state to cut off the electricity supplied from the battery 21 to the second switch circuit 32 when determining that there is a malfunction (e.g., an abnormally high current flowing through the motor 33 because a short circuit has occurred in the second switch circuit 32). Damage to the motor 33 and other components of the electric power tool may be prevented. Moreover, when it is determined by both the primary controller 51 and the secondary controller 52 that there is no malfunction, before enabling the switch-control circuit 31 to control the second switch circuit 32, the first switch circuit 24 is controlled to operate in the conducting state, thereby preventing the motor 33 from abnormal operation due to inappropriate control of the motor 33. It is worth to note that if the switch-control circuit 31 is enabled to control the second switch circuit 32 prior to the first switch circuit 24 being controlled to operate in the conducting state, since the first switch circuit 24 would operate in the non-conducting state when the PWM signal is outputted from the second switch circuit 32 to the motor 33, the PWM signal would deform for lacking the electricity from the battery 21, and once the first switch circuit 24 subsequently operates in the conducting state, the electricity from the battery 21 would be applied to the deformed PWM signal, thereby causing inappropriate control of the motor 33.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric power tool, comprising:
a power supply including
a battery that is configured to supply electricity, and
a first switch circuit that is electrically connected to said battery, and that is configured to receive the electricity supplied by said battery and to operate in one of a conducting state and a non-conducting state;
a driving unit including
a second switch circuit that is electrically connected to said first switch circuit, and that is configured to operate in one of a conducting state and a non-conducting state,
a motor that is electrically connected to said second switch circuit, and
a switch-control circuit that is electrically connected to said second switch circuit, and that is configured to control said second switch circuit to drive said motor;
a sensing unit configured to detect conditions of said power supply and said driving unit, and to output a detection result related to the conditions thus detected; and
a control unit including
a primary controller that is electrically connected to said power supply, said driving unit and said sensing unit, and that is configured to receive the detection result from said sensing unit, and
a secondary controller that is electrically connected to said power supply and said sensing unit, and that is configured to receive the detection result from said sensing unit,
wherein when said first switch circuit operates in the conducting state, said second switch circuit receives the electricity supplied by said battery from said first switch circuit, and provides, under control of said switch-control circuit, the electricity to said motor for driving said motor to operate,
wherein said primary controller is configured to disable said driving unit when it is determined by said primary controller that there is a malfunction based on the detection result, and
wherein said secondary controller is configured to control said first switch circuit to operate in the non-conducting state to cut off the electricity supplied from said battery to said second switch circuit when it is determined by said secondary controller that there is a malfunction based on the detection result.

2. The electric power tool as claimed in claim 1, wherein:
said primary controller and said secondary controller are in communication with each other and are further configured to provide information that is related to the detection result received from said sensing unit to each other;
said primary controller is further configured to determine whether there is a malfunction based on the detection result and the information provided by said secondary controller; and
said secondary controller is further configured to determine whether there is a malfunction based on the detection result and the information provided by said primary controller.

3. The electric power tool as claimed in claim 2, wherein:
said secondary controller is further configured to, when it is determined by both said primary controller and said secondary controller that there is no malfunction, control said first switch circuit to operate in the conducting state prior to said primary controller enabling said switch-control circuit to control said second switch circuit to provide the electricity to said motor for driving said motor to operate.

4. The electric power tool as claimed in claim 1, wherein said sensing unit includes a plurality of sensors, and at least one of the plurality of sensors is configured to output at least one detection signal to both said primary controller and said secondary controller, the detection result including the at least one detection signal.

5. The electric power tool as claimed in claim 4, wherein the plurality of sensors include a battery voltage sensor and a motor current sensor.

6. The electric power tool as claimed in claim 5, wherein said battery voltage sensor is configured to detect a voltage value of said battery.

7. The electric power tool as claimed in claim 5, wherein said motor current sensor is configured to detect a current value of said motor.

8. The electric power tool as claimed in claim 4, further comprising a striker, wherein the plurality of sensors include a striker sensor that is configured to determine whether said striker has returned to a predetermined position after a striking operation.

9. The electric power tool as claimed in claim 4, further comprising a safety component, wherein the plurality of sensors include a safety component sensor that is configured to determine whether said safety component is pressed.
